(19) United States
(12) Patent Application Publication
(10) Pub. No.: US 2007/0284367 A1
(43) Pub. Date: Dec. 13, 2007

(54) Optical disc destroying device

(76) Inventor: Mao-Sang Lin, Taipei County (TW)

Correspondence Address: BIRCH STEWART KOLASCH & BIRCH, PO BOX 747, FALLS CHURCH, VA, 22040-0747, US

(21) Appl. No.: 11/450,303

(22) Filed: Jun. 12, 2006

(51) Int. Cl. H05B 6/64

(52) U.S. Cl. 219/679

(57) ABSTRACT

The present invention discloses an optical disc destroying device, which comprises an upper clamp arm and a lower clamp arm. The rear ends of the upper and lower clamp arms are pivotally coupled with a pivotal pin so that the front ends thereof can be vertically opened and closed. The bottom surface of the upper clamp arm has an upper scratching plate, and the top surface of the lower clamp arm has a lower scratching plate. Both the upper and lower scratching plates have scratching teeth at the front ends thereof, which can dual-side clamp an optical disc and scratch the printed surface of the optical disc. Thereby, the optical disc is destroyed, and the data stored in the optical disc can no more be revealed.

### FIELD OF THE INVENTION

The present invention relates to a tool for destroying the printed surface of an optical disc, particularly to an optical disc destroying device, which has a simple structure and can be operated easily.

### BACKGROUND OF THE INVENTION

In an optical disc, such as CD (Compact Disc), VCD (Video Compact Disc), or DVD (Digital Video Disc), a series of recesses and platforms, which are transformed from data signals, is printed on the surface of the optical disc, and a laser beam is used to illuminate the surface of the optical disc so that the data can be read from the reflected laser light. In order to prevent data revealing, the readable surface of an optical disc should be destroyed before the optical disc is abandoned.

Refer to from FIG. 1 to FIG. 3 for a first conventional optical disc destroying device. As shown in the drawings, the first conventional optical disc destroying device comprises a body 1a, and the section of the body 1a appears like a U shape with an opening 2a. A guiding slot 3a extends inward from the opening 2a and separates the body 1a into an upper body 4a and a lower body 5a. Each of the upper body 4a and the lower body 5a has a basin 6a, and one lateral wall of each basin 6a has a scratching blade 7a projecting vertically. Each scratching blade 7a spans the directory region of an optical disc and has teeth 8a facing one surface of the optical disc. The perimeter of the basin 6a of either of the upper body 4a and the lower body 5a has a debris-blocking structure 9a. The debris-blocking structure 9a is formed of multiple needle-like matters 91a arranged in array. During using, the user inserts the optical disc a into the guiding slot 3a and uses the scratching blades 7a to scratch and destroy the surfaces of the optical disc a. When operating the conventional optical disc destroying device, the user has to clamp the upper and lower bodies 4a and 5a to grip the optical disc a with one hand, and simultaneously, the other hand of the user handles the optical disc a. As the rear joint of the upper and lower bodies 4a and 5a is closed fixedly, the flexibility of the opening 2a is pretty limited and hard for user to clamp it by hand. Besides, when the user does not insert the optical disc a into the guiding slot 3a horizontally completely, the inclined optical disc a will bump the scratching blade 7a and the debris-blocking structure 9a. Thus, the scratching blade 7a and the debris-blocking structure 9a may be bent, and the lifespan thereof may be decreased.

Refer to FIG. 4 for a second conventional optical disc destroying device. As shown in the drawing, the second conventional optical disc destroying device comprises: a base body 1b and a motor 2b. The motor 2b pivotally connects with a disc body 3b with a pivotal axle, and the interior of the disc body 3b has a scratching element 4b. The interior of the base body 1b has a basin 5b, and a slip-proof pad 6b is placed inside the basin 5b. During using, the user can place the optical disc a onto the slip-proof pad 6b and turns on the motor 2b to drive the disc body 3b to rotate. Thus, the scratching element 4b will scratch and destroy the surface of the optical disc a.

However, there is no fixing mechanism for the motor 2b in the second conventional optical disc destroying device. Besides, the slip-proof pad 6b cannot effectively prevent the slip of the optical disc a. Thus, the disc body 3b is likely to drive the optical disc a to rotate synchronically. Therefore, the destroyed depth may be insufficient, or the readable surface of the optical disc a may be destroyed non-uniformly.

### SUMMARY OF THE INVENTION

The primary objective of the present invention is to provide an optical disc destroying device, which comprises: an upper clamp arm and a lower clamp arm. Each rear end of the upper and lower clamp arms has a pair of through-holed lugs. A pivotal pin is inserted through those through-holed lugs to pivotally couple the upper and lower clamp arms so that the front ends thereof can be vertically opened and closed. The bottom face of the upper clamp arm has an upper scratching plate, and the top face of the lower clamp arm has a lower scratching plate. Both the upper and lower scratching plates have scratching teeth at the front ends thereof, which can clamp an optical disc and dual-side scratch the printed surface of the optical disc. Thereby, the optical disc is destroyed, and the data stored in the optical disc can no more be revealed. The optical disc destroying device of the present invention has a simple structure; thus, it can be operated easily and fabricated economically.

### BRIEF DESCRIPTION OF THE DRAWINGS

FIG. 1 is a plan view of a first conventional optical disc destroying device.

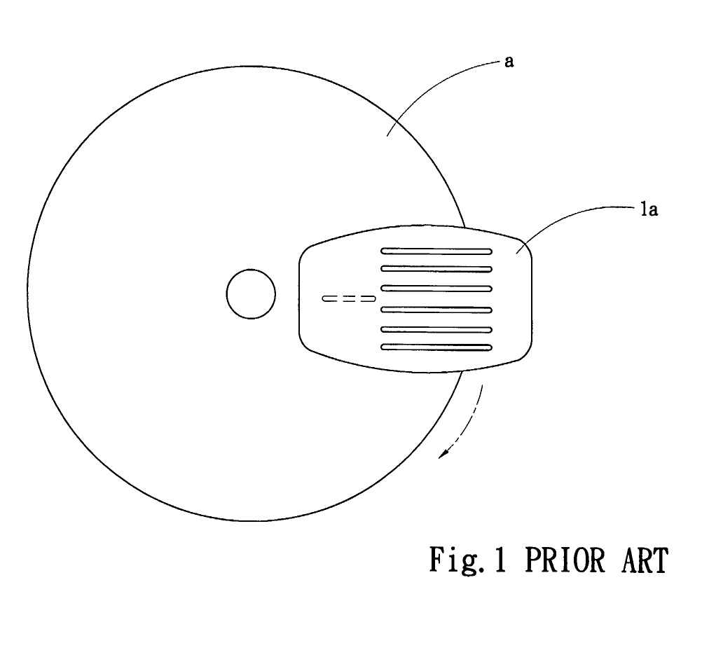

FIG. 2 is a sectional view of the first conventional optical disc destroying device.

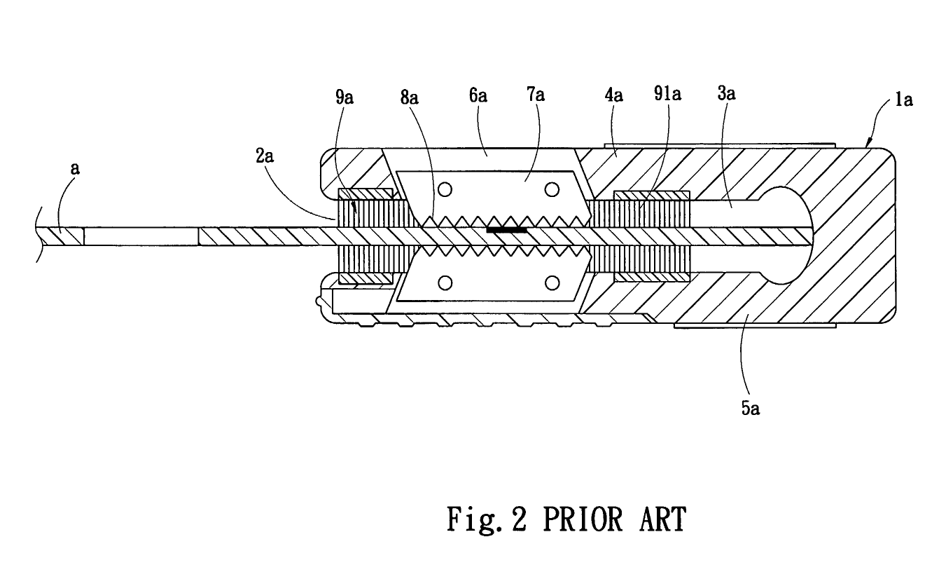

FIG. 3 is a perspective view of the first conventional optical disc destroying device.

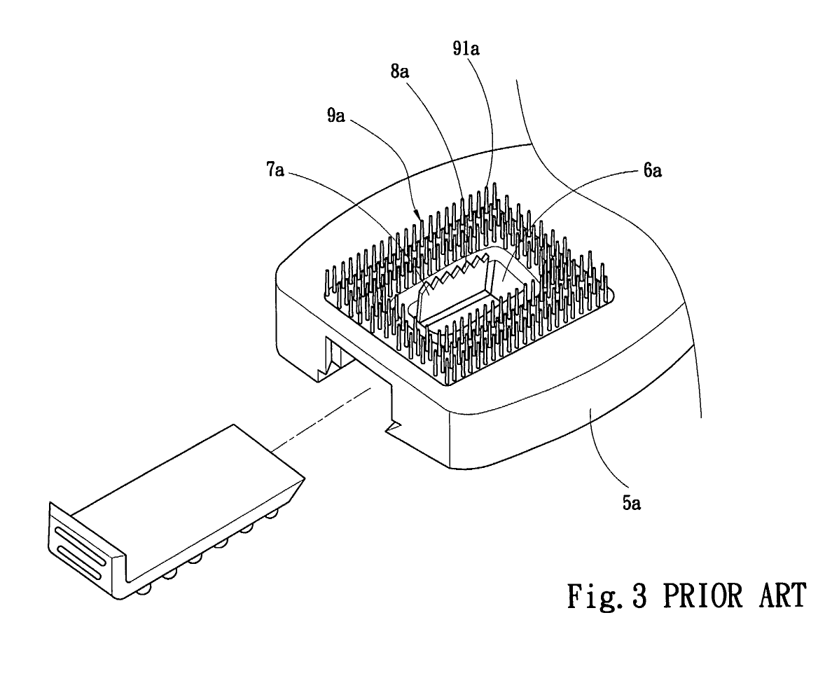

FIG. 4 is a sectional view of a second conventional optical disc destroying device.

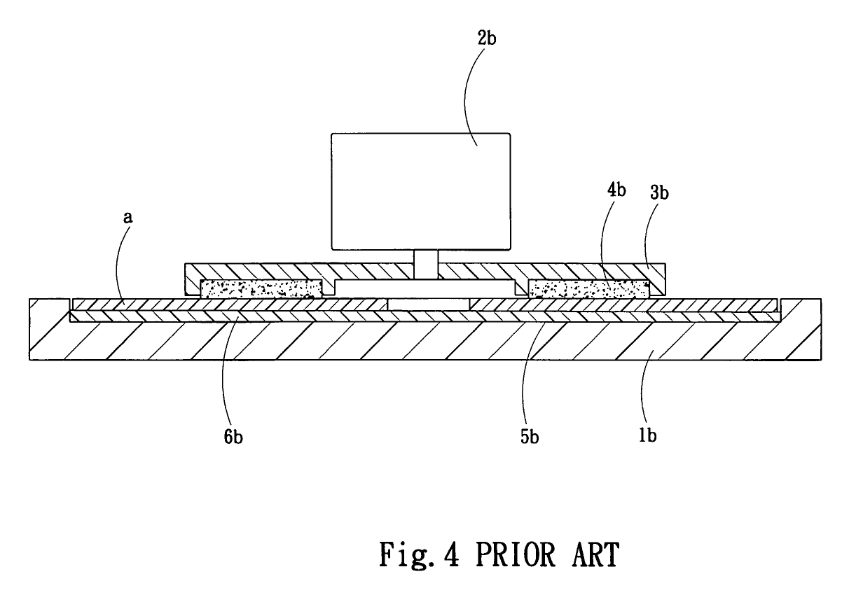

FIG. 5 is a perspective view schematically showing the optical disc destroying device according to a first preferred embodiment of the present invention.

FIG. 6 is a perspective exploded view schematically showing the optical disc destroying device according to the first preferred embodiment of the present invention.

FIG. 7 is a sectional view schematically showing the optical disc destroying device according to the first preferred embodiment of the present invention.

FIG. 8 is a diagram schematically showing the operation of the optical disc destroying device according to the first preferred embodiment of the present invention.

### DETAILED DESCRIPTION OF THE PREFERRED EMBODIMENTS

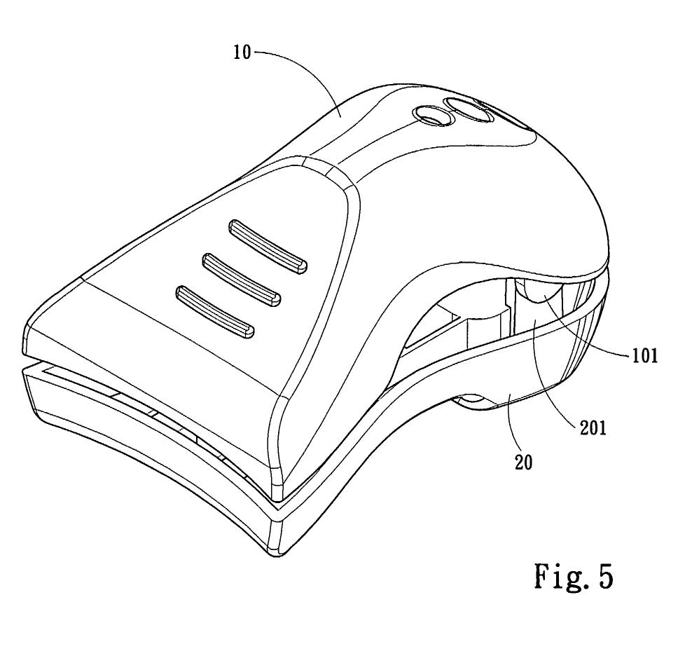

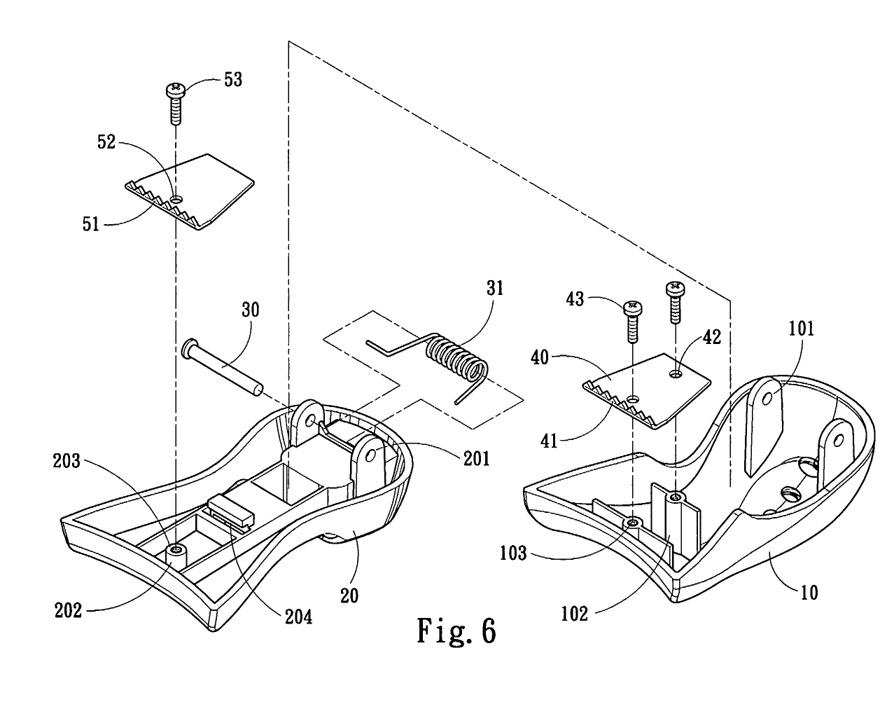

Refer to FIG. 5 and FIG. 6. The present invention is an optical disc destroying device, which comprises: an upper clamp arm 10, a lower clamp arm 20, a pivotal pin 30, an upper scratching plate 40, and a lower scratching plate 50. The upper clamp arm 10 appears like a clamshell with the opening facing downward and may be shaped to convenience the holding of a human hand. The rear end of the upper clamp arm 10 has a pair of through-holed lugs 101. The front end of the upper clamp arm 10 has two protuberances 102 projecting downward vertically, and the center of each protuberance 102 has a fixing hole 103, such as a threaded hole.

The lower clamp arm 20 is disposed corresponding to the upper clamp arm 10 and also appears like a clamshell but with the opening facing upward. The rear end of the lower clamp arm 20 has a pair of through-holed lugs 201, and the spacing between the pair of through-holed lugs 201 is smaller that the spacing between the pair of through-holed lugs 101. The front end of the lower clamp arm 20 has a protuberance 202 projecting upward vertically, and the center of the protuberance 202 has a fixing hole 203, such as a threaded hole. Besides, a clamping slot 204 is installed behind the protuberance 202.

The pivotal pin 30 penetrates through the through-holed lugs 101 of the upper clamp arm 10, the through-holed lug 201 of the lower clamp arm 20, and an elastic element 31 (such as a spring), which can expand and contract axially. One end of the elastic element 31 presses against the through-holed lug 101 of the upper clamp arm 10, and the other end of the elastic element 31 presses against the top face of the lower clamp arm 20, so that the front ends of the upper and lower clamp arms 10 and 20 can open or close elastically.

The upper scratching plate 40 has a transverse row of scratching teeth 41, which protrude downward and are vertical to the upper scratching plate 40. The upper scratching plate 40 has two through holes 42 disposed corresponding to those two fixing holes 103 of the upper clamp arm 10. Fixing elements 43, such as screws, penetrate through the through holes 42 of the scratching plate 40 and are locked by the fixing holes 103 so that the upper scratching plate 40 can be fastened to the bottom face of the upper clamp arm 10.

The lower scratching plate 50 is disposed corresponding to the upper scratching plate 40 and has a transverse row of scratching teeth 51, which protrude upward and are vertical to the lower scratching plate 50. The scratching teeth 51 has a through hole 52 at the rear end and the lower scratching plate 50 is inserted into a clamping slot 204 of the lower clamp arm 20. The lower scratching plate 50 has a through hole 52 disposed corresponding to the fixing hole 203 of the lower clamp arm 20. A fixing element 53, such as a screw, penetrates through the through hole 52 of the scratching plate 50 and is locked by the fixing hole 203. Thereby, the lower scratching plate 50 can be fastened to the top face of the lower clamp arm 20.

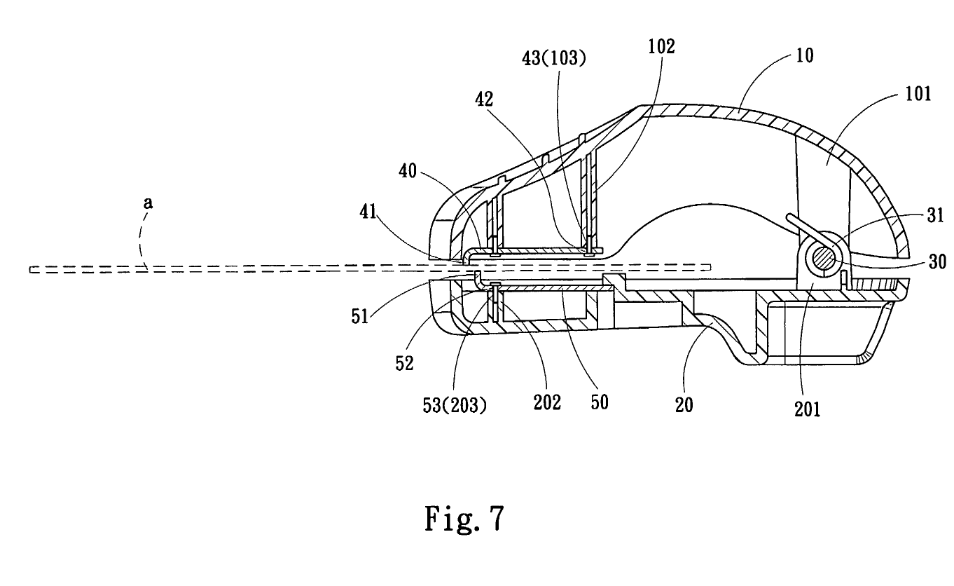

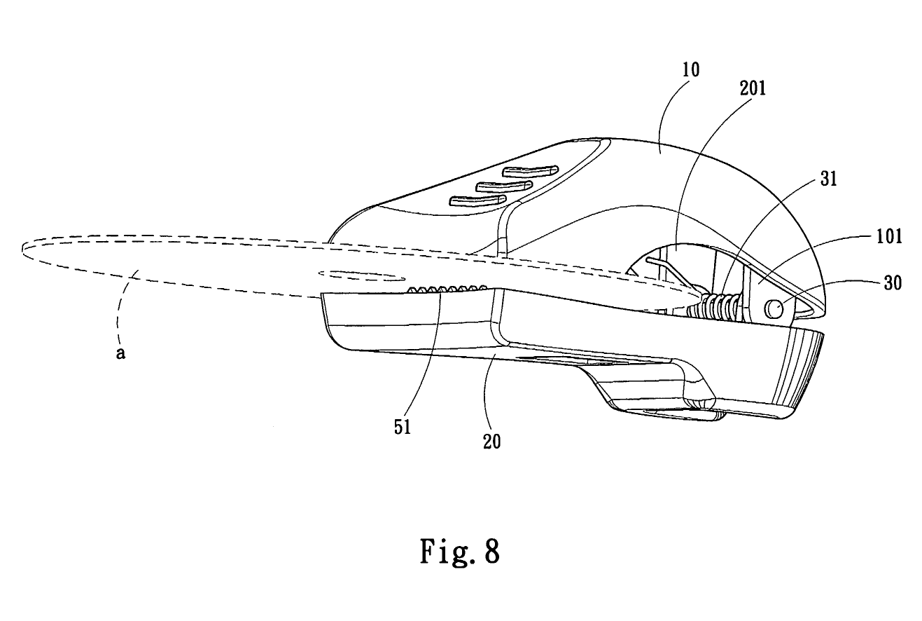

Refer to FIG. 7. The pivotal pin 30, which penetrates through the through-holed lugs 101 and 201 of the upper and lower clamp arms 10 and 20, also penetrates through the elastic element 31; therefore, the front ends of the upper and lower clamp arms 10 and 20 are normally opened, and there is normally an appropriate gap between the upper scratching plate 40 and the lower scratching plate 50 for the insertion of an optical disc a. Refer to FIG. 8. The user can simultaneously hold the upper and lower clamp arms 10 and 20 with hand; thus, the scratching teeth 41 and 51 of the upper and lower scratching plates 40 and 50 will tightly clamp the optical disc a. When the user moves the device of the present invention toward the rim of the optical disc a, multiple scratches will be formed. Thus, the printed layer of the optical disc a will be thoroughly destroyed, and the data stored in the optical disc is no more revealable.

In summary, the samples of the present invention have been tested for numerous times, and the test results prove that the device of the present invention can really destroy the printed layer of an optical disc and can prevent data from being revealed. It is worth noting: as the device of the present invention has a simple structure, it can be operated easily and fabricated economically. Besides, until the filing date of the present invention, no similar product is found in the markets and the published data. Therefore, the present invention indeed possesses the novelty and non-obviousness demanded by the regulations. Thus, the Inventor files the patent application for the present invention.

Those described above are only the preferred embodiments to clarify the present invention. However, it is not intended to limit the scope of the present invention, and any equivalent modification and variation according to the spirit of the present invention is to be also included within the scope of the claims of the present invention.

What is claimed is:

1. An optical disc destroying device, comprising:
an upper clamp arm, having a pair of through-holed lugs at the rear end thereof, and having an upper scratching plate with a row of scratching teeth projecting downward at the front end thereof;
a lower clamp arm, disposed corresponding to said upper clamp arm, having a pair of through-holed lugs at the rear end thereof, and having an lower scratching plate with a row of scratching teeth projecting upward at the front end thereof;
a pivotal pin, transversely penetrating through said through-holed lugs of said upper clamp arm and said through-holed lugs of said lower clamp arm.

2. The optical disc destroying device according to claim 1, wherein said pivotal pin penetrates through an elastic element, which can expand and contract axially, so that the front ends of said upper clamp arm and said lower clamp arm can open and close elastically.

3. The optical disc destroying device according to claim 1, wherein said upper clamp arm appears like a hollow clamshell with its opening facing downward and is hat-shaped to convenience the holding of a human hand; said lower clamp arm also appears like a hollow clamshell but with its opening facing upward.

4. The optical disc destroying device according to claim 1, wherein the front end of said upper clamp arm has two protuberances projecting downward vertically, and the center of each said protuberance has a fixing hole for a fixing element penetrating through a through hole of said upper scratching plate and locked thereto so that said upper scratching plate can be fastened to the bottom face of said upper clamp arm.

5. The optical disc destroying device according to claim 1, wherein the front end of said lower clamp arm has a protuberance projecting upward vertically, and a clamping slot installed behind said protuberance ; the center of said protuberance has a fixing hole, and the rear side of said lower scratching plate is inserted into said clamping slot; a fixing element penetrates through a through hole of said lower scratching plate and is locked into said fixing hole; thereby, said lower scratching plate can be fastened to the top surface of said lower clamp arm.
